(19) United States
(12) Patent Application Publication
(10) Pub. No.: US 2004/0001094 A1
(43) Pub. Date: Jan. 1, 2004

(54) Automatic identification of drop zones

(76) Inventors: Johannes Unnewehr, Heidelberg (DE); Jochen Guertler, Karlsruhe (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/233,075

(22) Filed: Aug. 29, 2002

Related U.S. Application Data
(60) Provisional application No. 60/393,053, filed on Jun. 28, 2002.

(51) Int. Cl. G09G 5/00

(52) U.S. Cl. 345/769

(57) ABSTRACT

Systems and techniques to automatically identify drop zones when a source object is selected. In general, in one implementation, the technique includes: targeting a source object; and, in response to targeting the source object, marking available drop zones.

### CROSS REFERENCE TO RELATED APPLICATIONS

This application claims priority to U.S. Provisional Patent Application Serial No. 60/393,053, filed on Jun. 28, 2002 and entitled “COLLABORATIVE ROOM,” which is incorporated by reference.

### BACKGROUND

The present application describes systems and techniques relating to “drag and drop” operations, for example, the automatic identification of drop zones.

A “drag and drop” operation refers to an operation in which a user targets a screen object by using a pointing device, such as a mouse, to position a pointer on the display screen over a screen object, selects the screen object by depressing a button on the pointing device, uses the pointing device to move the selected screen object to a destination, and releases the button to drop the screen object on the destination. Typically, after releasing the mouse button, the screen object appears to have moved from where it was first located to the destination.

The term “screen objects” refers generally to any object displayed on a video display. Such objects include, for example, representations of files, folders, documents, databases, and spreadsheets. In addition to screen objects, the drag and drop operation may be used on selected information such as text, database records, graphic data or spreadsheet cells.

### SUMMARY

The present application teaches systems and techniques for automatically identifying to a user available drop zones during a drag and drop operation.

In one aspect, when a user targets a source object, available destinations for the source object, also referred to as “targets” or “drop zones,” are marked, e.g., by highlighting. The drop zones may be marked by shading, changing color, outlining, or presenting indicative text. The marking may be removed when the source object is dropped on one of the drop zones or when the source object is de-selected.

In another aspect, each drop zone may be associated with one or more particular object types. When a source object is selected, the object type is determined, and only the drop zone(s) associated with that type are marked.

In alternative aspects, the marking of the drop zones may not be triggered until a source object is selected, e.g., with a mouse button, or dragged.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 shows a block diagram of a computer system.

FIG. 2 is a block diagram of a screen display illustrating a drag and drop operation.

FIG. 3 is a flowchart describing a drop zone identification operation.

FIG. 4 is a screen display prior to the targeting of a source object.

FIG. 5 is a screen display showing marked drop zones.

FIG. 6 is a screen display after a “drag and drop” operation has been performed.

FIG. 7 is a flowchart describing a drop zone identification operation.

FIG. 8 is a screen display including marked drop zones according to the technique described in FIG. 7.

FIG. 9 is another screen display including marked drop zones according to the technique described in FIG. 7.

Like reference symbols in the various drawings indicate like elements.

### DETAILED DESCRIPTION

The systems and techniques described here relate to drag and drop operations.

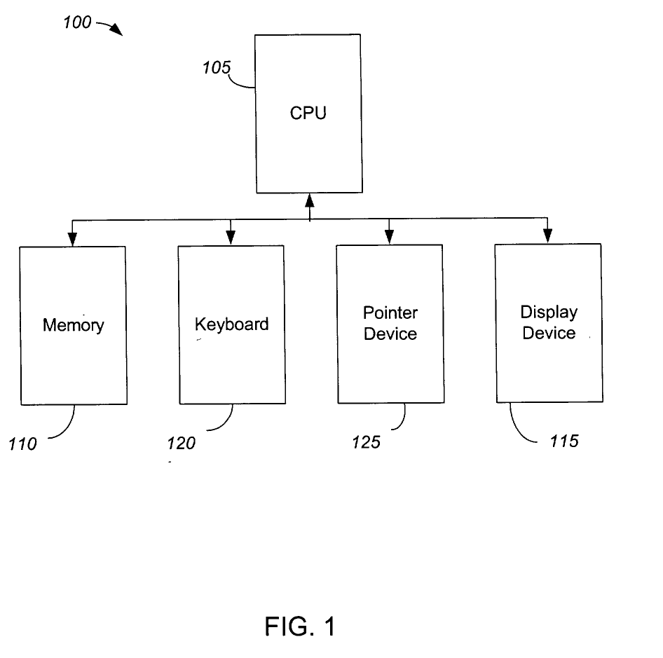

FIG. 1 illustrations a computer system 100, which may provide a user interface that automatically identifies drop zones for a selected “source” object in a “drag and drop” operation. This automatic identification provides the user with an immediate visual clue as to which destinations, or “drop zones” are available on the display for the source object.

The computer system 100 may include a CPU (Central Processing Unit) 105, memory 110, a display device 115, a keyboard 120, and a pointer device 125, such as a mouse. The CPU 105 may run application programs stored in the memory or accessed over a network, such as the Internet.

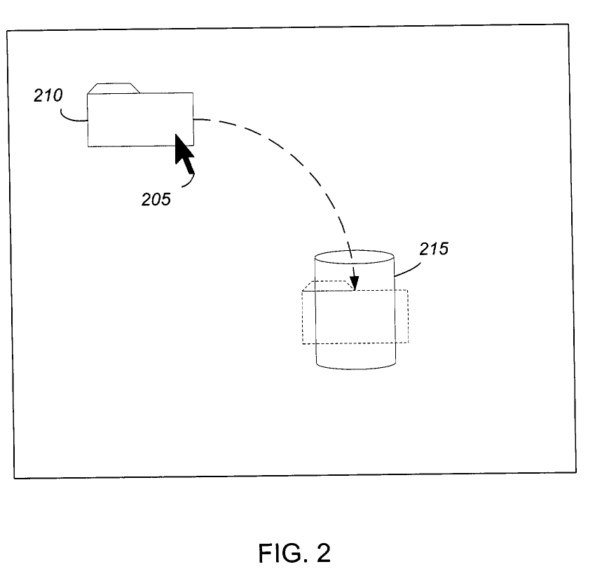

The computer system may 100 provide a GUI. The GUI may represent objects and applications as graphic icons on the screen display, as shown in FIG. 2. The user may target, select, move, and manipulate (e.g., open or copy) an object with a pointer 205 controlled by the pointer device 125.

The GUI may support a drag and drop operation in which the user targets a source object, e.g., a folder 210, using the pointer 205. The user may then select the source object by, e.g., clicking a button on the pointer device 125. While still holding down the button, the user may drag the selected object to a destination, e.g., a recycle bin 215. Typically, after releasing the button, the source object appears to have moved from where it was first located to the destination.

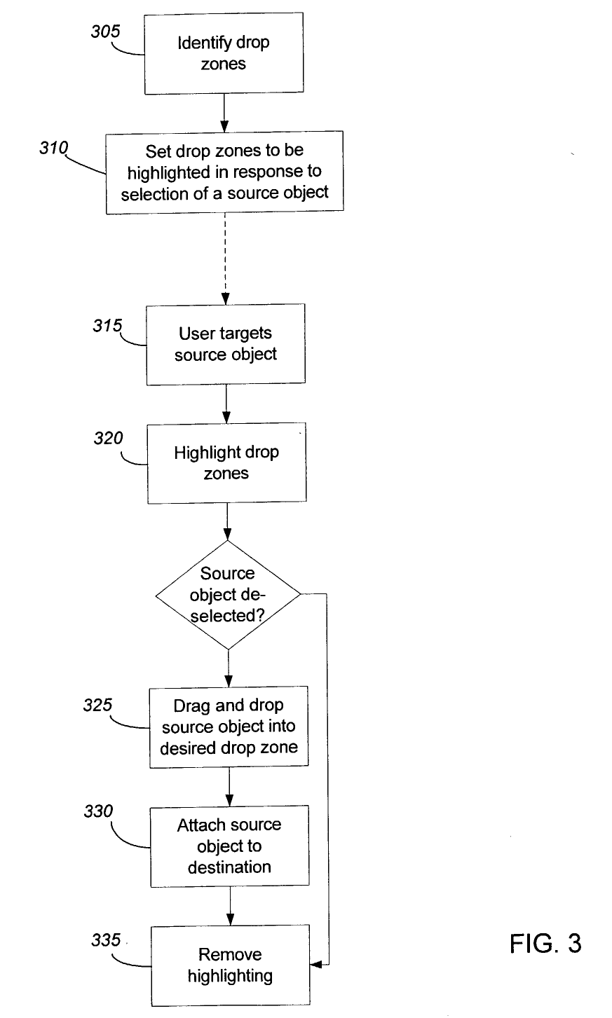

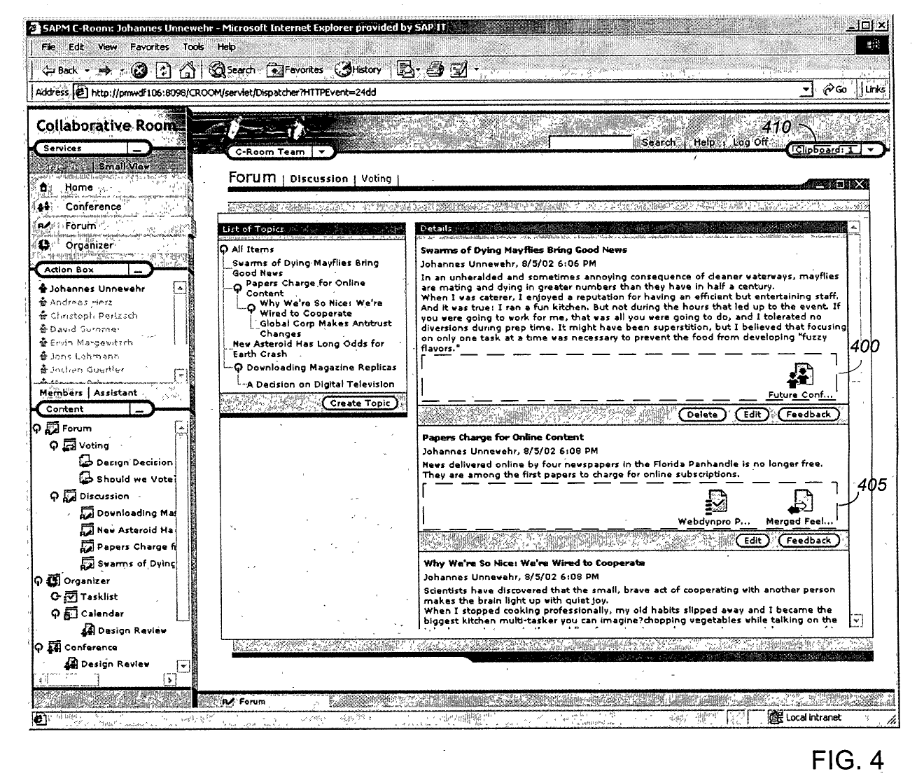

FIG. 3 shows a flowchart describing a drop zone identification operation. Possible destinations for source objects, i.e., “drop zones,” may be identified manually (e.g., by the developer) or automatically by the GUI or the underlying operating system (O/S) (block 305). A drop zone may be a region of a window, e.g., regions 400 and 405, or a screen object 410, as shown in FIG. 4 (the dashed lines in the FIG. 4 are shadow lines used to identify the zones, and are not part of the actual display). These drop zones are set to be marked when a source object is targeted or selected (block 310). For example, the marking of the drop zones maybe triggered (a) when the pointer 205 is moved within the active region, or “hot spot,” of a source object, (b) when the user selects the source object, e.g., by pressing a mouse button, or (c) when the user begins to drag the source object. The “marking” may include, for example, highlighting the drop zones, e.g., by shading or changing the color of the drop zones, outlining the drop zones, or presenting text indicating drop zones. The marking may be persistent or flashing while the source object is selected.

In a typical GUI, the availability of a potential target location is only visually represented when the source object is dragged over the target location. The availability of the target location may be identified, e.g., by marking an available destination and by replacing the pointer 205 with a circle-with-bar symbol for an unavailable destination (e.g., a “no-drop zone”). However, this approach provides no visual clues to the user while the user is dragging the source object.

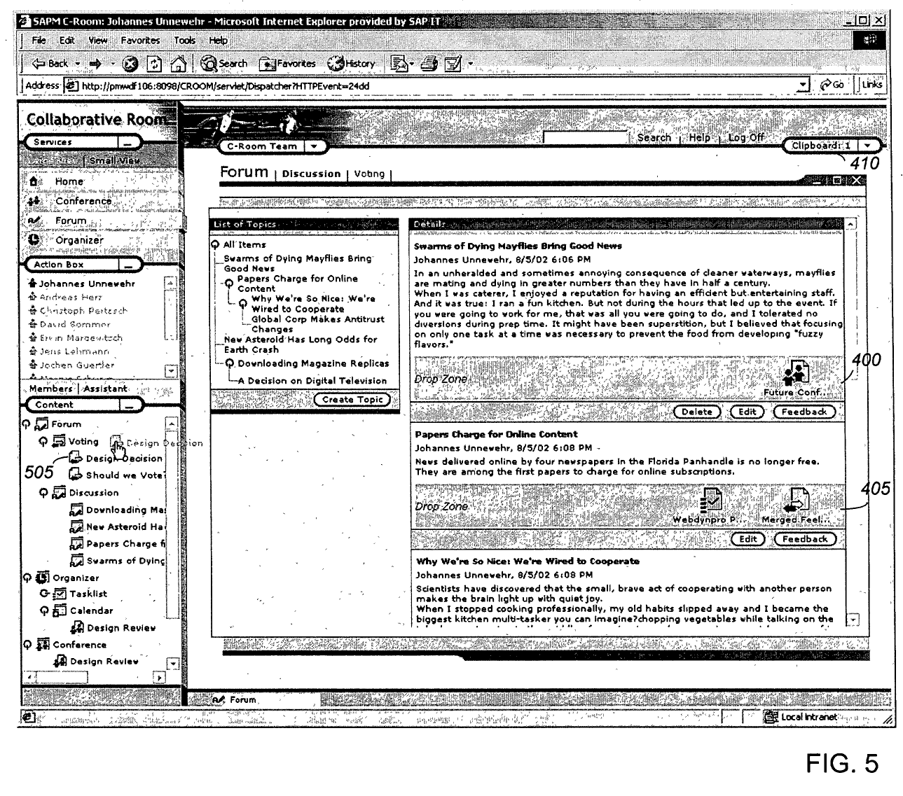

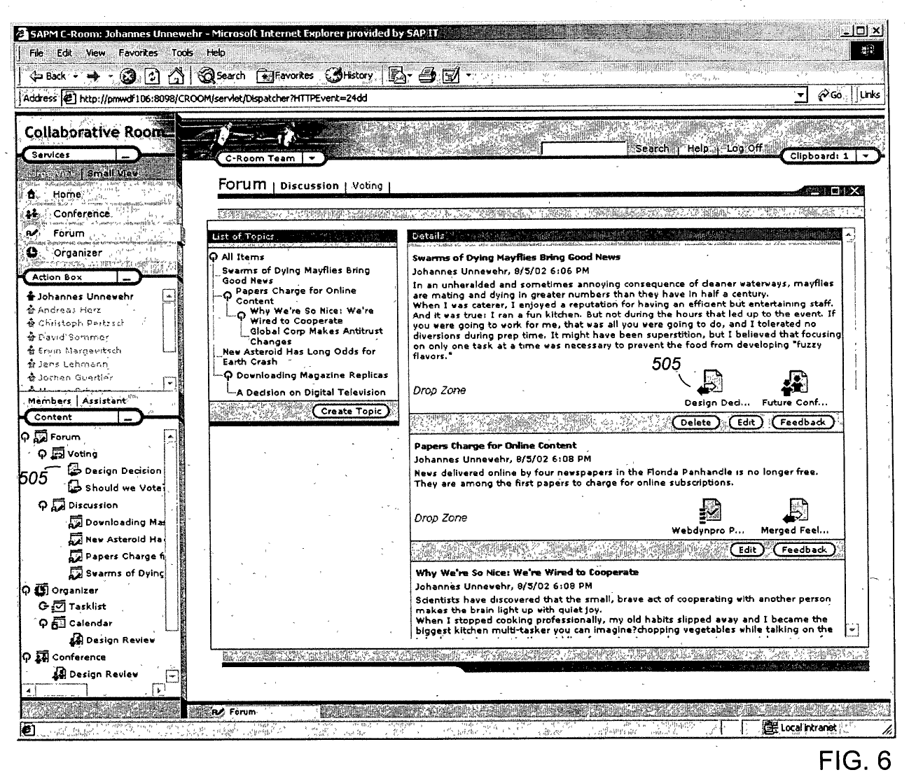

In an exemplary operation, when the user targets a source object 505 (block 315), all drop zones 400, 405, 410 in the display (or current operating window or portal) are marked (block 320), as shown in FIG. 5. The user may then drag and drop the source object 505 into a desired drop zone 400 (block 325). An operation is then performed on the source object and the destination, e.g., relating, associating, or attaching the source object to the destination, as shown in FIG. 6. The marking may be removed from all of the drop zones 400, 405, 410 when the source object 505 is dropped or de-selected (e.g., by releasing the button on the pointer device 125) (block 335).

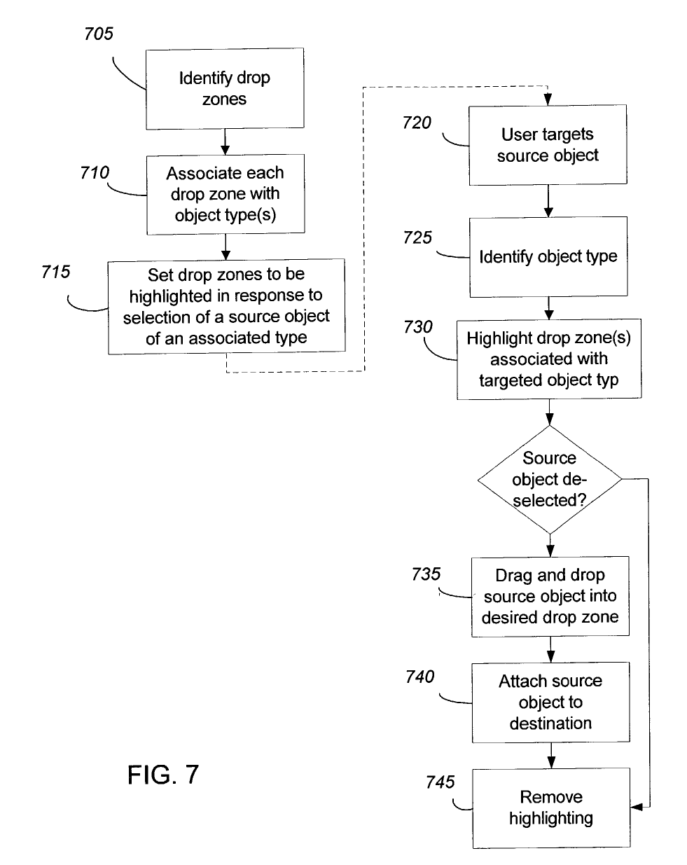

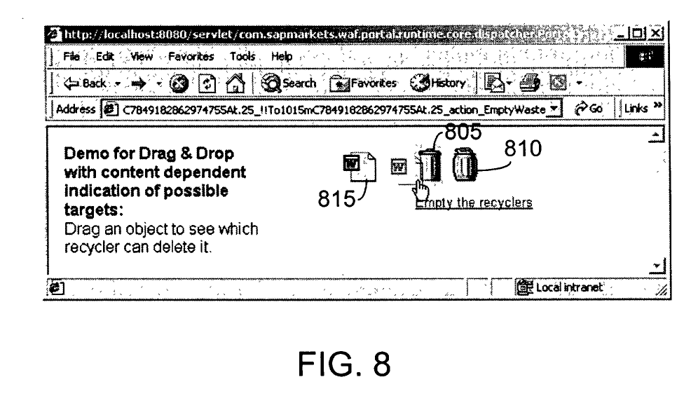

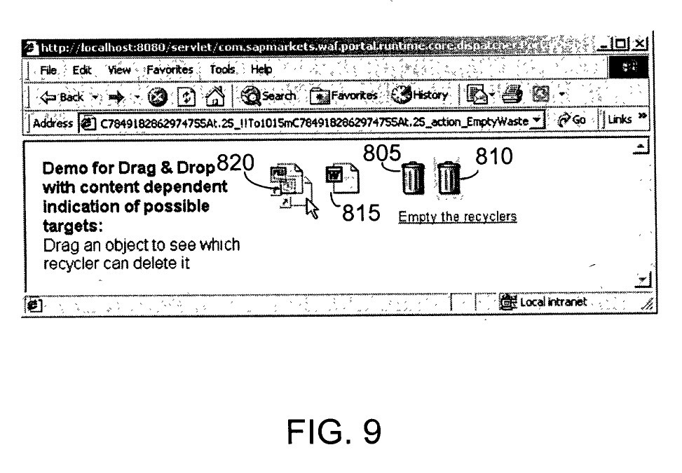

FIG. 7 shows a flowchart describing an alternative drop zone identification operation. The drop zones may be identified manually or automatically (block 705). Each of the drop zones may be associated with one or more particular object types (block 710). The drop zones are set to be marked only in response to source object of the appropriate type being targeted, selected, or dragged (block 715). For example, in the display 800 shown in FIGS. 8 and 9, a document recycler object 805 is associated with word processing files and a presentation recycler object 810 is associated with slide presentation files.

When the user targets a source object (block 720), the process determines the type of the object (block 725). The object type may be determined from a file extension, e.g., “DOC” for the Microsoft® Word word processing application and “PPT” for the Microsoft® PowerPoint® slide presentation application. The object type may also be determined from other data associated with or contained in the object. If the object targeted by the user is a word processing file 815, only the document recycler 805 (and any other destinations associated with the word processing file type) is marked (block 730), as shown in FIG. 8. If the object targeted by the user is a slide presentation file 820, only the presentation recycler 810 (and any other destinations associated with the word processing file type) is marked (block 730), as shown in FIG. 9.

The user may then drag and drop the source object into a desired drop zone (block 735). The source object is then attached to the destination (block 740). The marking may be removed from the drop zone(s) associated with the source object type when the source object is dropped or de-selected (block 745).

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

Although only a few embodiments have been described in detail above, other modifications are possible. For example, a reverse identification may be performed. When a destination associated with a source object type is targeted or selected, all potential source objects having that object type are marked.

The logic flows depicted in FIGS. 3 and 7 do not require the particular order shown, or sequential order, to achieve desirable results. For example, removing the marking from the available destinations may be performed at different places within the overall process. In certain implementations, multitasking and parallel processing may be preferable.

Other embodiments may be within the scope of the following claims.

What is claimed is:

1. A method comprising:
targeting a source object; and
in response to said targeting, marking a plurality of drop zones to which the source object may be dropped.

2. The method of claim 1, further comprising:
dragging the source object to one of the plurality of drop zones;
dropping the source object on said one of the plurality of drop zones; and
removing the marking from the drop zones.

3. The method of claim 1, wherein said marking is further in response to selecting the source object

4. The method of claim 3, further comprising:
de-selecting the source object; and
removing the marking from the drop zones.

5. The method of claim 3, wherein said marking is further in response to dragging the source object.

6. The method of claim 1, wherein said marking comprises shading the drop zones.

7. The method of claim 1, wherein said marking comprises changing the color of the drop zones.

8. The method of claim 1, wherein said marking comprises outlining the drop zones.

9. The method of claim 1, wherein said marking comprises presenting text indicating the drop zones.

10. A method comprising:
targeting an object having a type;
identifying the type of the object; and
marking a drop zone associated with said type.

11. The method of claim 10, further comprising:
dragging the source object to the drop zone;
dropping the source object on the drop zone; and
removing the marking from the drop zone.

12. The method of claim 10, wherein said marking is further in response to selecting the source object.

13. The method of claim 12, further comprising:
de-selecting the source object; and
removing the marking from the drop zone.

14. The method of claim 12, wherein said marking is further in response to dragging the source object.

15. The method of claim 10, wherein said marking comprises shading the drop zones.

16. The method of claim 10, wherein said marking comprises changing the color of the drop zones.

17. The method of claim 10, wherein said marking comprises outlining the drop zones.

18. The method of claim 10, wherein said marking comprises presenting text indicating the drop zones.

19. The method of claim 1, further comprising:
targeting a destination associated with a type;
identifying the type; and
marking one or more objects having the type.

20. An article comprising a machine-readable medium storing instructions operable to cause one or more machines to perform operations comprising:
targeting a source object; and
in response to said targeting marking a plurality of drop zones to which the source object may be dropped.

21. The article of claim 20, further comprising instructions operable to cause one or more machines to perform operations comprising:
dragging the source object to one of the plurality of drop zones;
dropping the source object on said one of the plurality of drop zones; and
removing the marking from the drop zones.

22. An article comprising a machine-readable medium storing instructions operable to cause one or more machines to perform operations comprising:
targeting an object having a type;
identifying the type of the object; and
marking a drop zone associated with said type.

23. The article of claim 22, further comprising instructions operable to cause one or more machines to perform operations comprising:
dragging the source object to the drop zone;
dropping the source object on the drop zone; and
removing the marking from the drop zone.
